(19) United States
(12) Patent Application Publication
(10) Pub. No.: US 2004/0025862 A1
(43) Pub. Date: Feb. 12, 2004

(54) Vented burner shield for use with a gas burner element

(75) Inventors: Hing Lor, Columbus, GA (US); Justin P. Carlson, Columbus, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: W.C. BRADLEY COMPANY, Columbus, GA (US)

(21) Appl. No.: 10/215,836

(22) Filed: Aug. 9, 2002

(51) Int. Cl. F24C 3/00; A47J 37/00

(52) U.S. Cl. 126/41 R; 126/39 K; 126/39 J

(57) ABSTRACT

A vented burner shield for use with a burner element of a grill, the shield including a first and a second sloped surface, each of said first and second sloped surfaces having a proximal edge and a distal edge, the proximal edge being adjacent a central ridge and the first and second sloped surfaces sloping downwardly therefrom. Also included is a pair of opposed edges, each of the opposed edges are disposed at opposing ends of said central ridge, and at least one corner edge, the corner edge intersecting one of said proximal edges and one of said opposed edges.

### TECHNICAL FIELD

The present invention relates generally to barbecue grills, and, more particularly, to vented burner shields for use with gas burner elements.

### BACKGROUND OF THE INVENTION

In the recent past, outdoor cooking has experienced tremendous growth. This is due in large part to the fact that barbecue grills, both charcoal and gas, have become much easier to use and more efficient at cooking a wide range of food items. Although both charcoal and gas barbecue grills have seen improvements in the recent years, the advantages of gas barbecue grills have been well recognized. Gas barbecue grills can quickly bring a heated surface to a desired temperature and may provide a high rate of heat exchange. Therefore, gas barbecue grills generally require less time to prepare food items than do charcoal grills. As well, gas barbecue grills allow for finer control of cooking temperatures than do charcoal barbecue grills. Although gas barbecue grills offer a number of advantages, there are still a number of disadvantages, that if addressed, could improve the overall cooking experience.

Existing gas barbecue grills generally utilize multiple rows of burner elements located in various locations beneath the cooking surface. Typical burner elements are a series of tubes with nozzles provided at discrete locations along the tube. As such, when fuel is provided to the burner elements, the fuel is burned only at those discrete locations where a nozzle is present. Because each individual nozzle provides a flame only to a limited area, hot and cold zones develop beneath the cooking surface. Hot zones develop directly over each individual nozzle flame, and cool zones develop between the nozzle flames. Moreover, the problem of forming hot and cold zones under the cooking surface can be exacerbated by the shape of the burners themselves. Typical burner elements such a bar burners and H-burners are generally irregularly shaped in order to fit within the confines of the bottom casing or firebox of the barbecue grill. Tubular burners, while regularly shaped, may not span the length or width of the firebox due to design limitations. Previous efforts to correct the development of hot and cold zones have been largely ineffective. Another known approach is to use “tented burners” in gas barbecue grills. Although tented burners do tend to help control flare-ups, known tented burner arrangements are largely ineffective in providing an optimum, and even, distribution of heat underneath the cooking surface of the barbecue grill.

Therefore, a need exists for gas burner elements for use in barbecue grills that reduce flare-ups and provide more even heat distribution.

### SUMMARY OF THE INVENTION

Embodiments of the present invention include a vented burner shield for use with a burner element of a grill, the shield including a first and a second sloped surface, each of said first and second sloped surfaces having a proximal edge and a distal edge, the proximal edge being adjacent a central ridge and the first and second sloped surfaces sloping downwardly therefrom. Also included is a pair of opposed edges, each of the opposed edges are disposed at opposing ends of said central ridge, and at least one corner edge, the corner edge intersecting one of said proximal edges and one of said opposed edges.

Other features and advantages of the present invention will become apparent to one with skill in the art upon examination of the following drawings in detail description. It is intended that all such features and advantages be included herein within the scope of the present invention, as defined in the appended claims.

### BRIEF DESCRIPTION OF THE DRAWINGS

The present invention, as defined in the claims, can be better understood with reference to the following drawings. The components in the drawings are not necessarily to scale relative to each other, emphasis instead being placed upon clearly illustrating the principles of the present invention.

FIG. 1 is a partial perspective view of a gas burner element and an associated vented burner shield constructed according to an embodiment of the present invention.

FIG. 2 is a side elevational view of the vented burner shield as shown in FIG. 1.

FIG. 3 is an end elevational view of the vented burner shield shown in FIG. 1.

FIG. 4 is a top plan view of the vented burner shield shown in FIG. 1.

### DETAILED DESCRIPTION OF THE PREFERRED EMBODIMENTS

In the following detailed description, reference is made to the accompanying drawings which form a part hereof, and in which are shown by way of illustrations specific embodiments of vented burner shields for use in gas barbecue grills. It is to be understood that other embodiments may be utilized and structural or process changes made be made. The following detailed description, therefore, is not to be taken in a limiting sense.

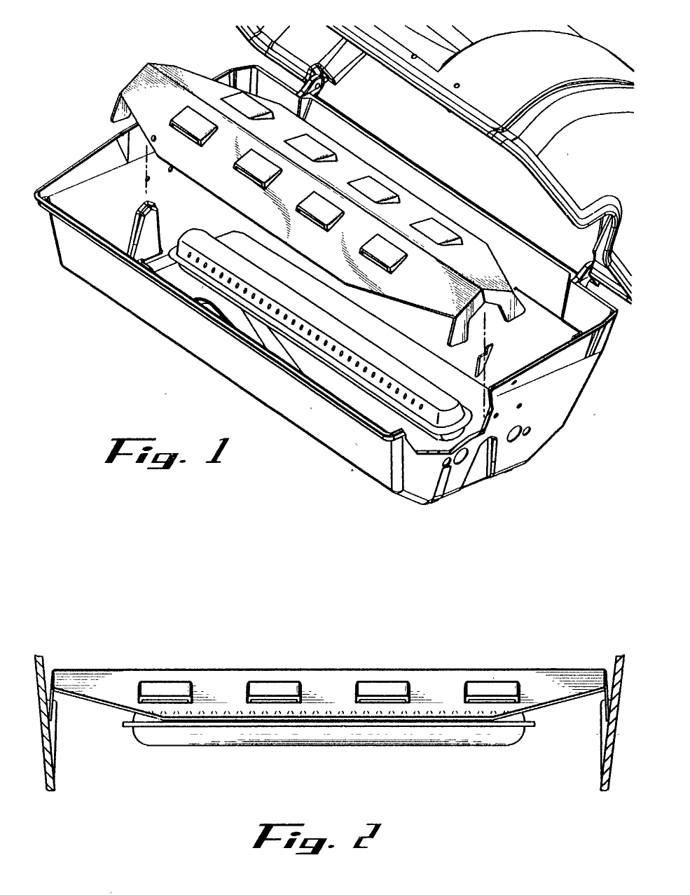

Referring now to the figures, wherein like reference numerals indicate corresponding components throughout the several views, one example of a vented burner shield constructed in accordance with the present invention is illustrated in FIG. 1. As shown in this figure, the vented burner shield 100 is disposed above a gas burner element 140. A vented burner shield 100 having improved heat distribution characteristics includes a first sloped surface 102, and a second sloped surface 104 each having a main body portion 101, with a defined surface area and end portions 103 having a reduced surface area relative to the main body portions. Each of the first and second sloped surfaces 102, 104 has a proximal edge 106 and a distal edge 108, the proximal edges 106 being adjacent to each other such that the first and second sloped surfaces 102, 104 form an inverted “V”-shape with the sloped surfaces 102, 104 extending downwardly from a central ridge 110. Preferably, the sloped surfaces 102, 104 approximately form a 120° angle therebetween. However, various other angles are within the scope of the present vented burner shield 100. A pair of opposed edges 112 run along the sloped surfaces 102, 104 at opposing ends of the central ridge 110. Preferably, two (FIG. 2) angular corner edges 114 extend, one each, from each distal edge 108 to a different one of the opposed edges 112, meaning there are preferably four corner edges 114. Embodiments of the vented burner shield 100 are envisioned with fewer corner edges 114.

Preferably, the vented burner shield 100 also includes a plurality of vents 120 formed in each of the sloped surfaces 102, 104 and a pair of flange portions 130 disposed at opposing ends of the central ridge 110 along the opposing edges 112. As shown in FIG. 2, the vents are slots 122 disposed along the bottom edge of the raised portions 124 formed in each of the sloped surfaces 102, 104. The preferred construction of the vents provides for the even distribution of heat along the length of the sloped surfaces 102, 104 while at the same time the sloped surfaces and the raised portions 124 act as deflectors thereby preventing grease, food particles, debris, etc., from passing through the slots 122 and contacting the burner element 140. Therefore, while the slots 122 provide for the even distribution of heat, the sloped surfaces and the raised portions 124 protect against flare-ups and reduce the possibility that the nozzles 142 on the burner element 140 will become clogged. In addition, the vents 120 allow the operator to determine if the gas burner element 140 is lit in that the flames are visible therethrough. Other embodiments include vents 120 of various shapes, such as circular, square, rectangular, etc.

Preferably, the vented burner shield 100 is positioned above its associated gas burner element or elements by engaging support members 164 disposed on the casting 162 of the barbecue grill 160 with the flange portions 130, which are configured to securely support the vented burner shield 100. Although numerous configurations are envisioned for the flange portions 130, as shown in FIG. 3, each flange portion 130 includes a pair of legs 132 separated from each other by a gap 134 and from an associated corner edge 114 by a passage 136. The preferred configuration ensures the vented burner shield 100 is securely disposed above the gas burner element 140.

Prior art burner shields have typically been regularly shaped, that is, the sloped surfaces are generally identical and extend from one end or side of the grill to the other. The present invention provides an improvement to such designs by the inclusion of the inwardly angled ends or edges 114. Most problems with cold spots at the cooking surface exist at the outward comers thereof. The angular displacement of the ends of the present shield allows more heat to be directed outwardly at the ends of the burner or burners, whether they extend from front to back or from side to side, as shown in FIG. 1. While shown and described herein as angular, the end portions can have other shapes which are considered to be within the scope of the present invention. For example, the ends could have a curved shape or a perforated surface, the concept being a reduced surface area to allow heat from the burner to emanate outwardly toward the corners of the cooking surface. Heat is also distributed through the gaps 134 and passages 136 with the combined effect of preventing the formation of cold spots at the ends of the vented burner shield 100.

Embodiments are envisioned that do not include flange portions 130, the vented burner shield 100 instead being supported at opposing ends of the central ridge 110 by the support members 164 extending from the grill. Embodiments of the vented burner shield 100 are possible wherein the ends of the corner edges 114 opposite the distal edge 108 meet at a respective end of the central ridge 110, meaning no pair of opposing edges 112 is present and the ends of the vented burner shield 100 are in effect pointed. These embodiments are particularly suited for being supported by elements extending from the grill, but can also include flange portions 130 as discussed herein.

Preferably, the vented burner shield 100 is constructed of stainless steel for prevention of corrosion and increased durability. However, many metals exhibit acceptable heat transfer characteristics as well as reasonable workability for the manufacturing process.

Thus, while an embodiment and modifications thereof of a vented, burner shield have been shown and described herein, various additional changes and modifications may be made without departing from the scope of the present invention, as defined by the appended claims.

Therefore, having thus described the invention, at least the following is claimed:

1. A vented burner shield for use with a burner element of a grill, comprising:
a first and a second sloped surface, each of said first and second sloped surfaces having a proximal edge and a distal edge, said proximal edge being adjacent a central ridge and said first and second sloped surfaces sloping downwardly therefrom;
a pair of opposed edges, each of said opposed edges being disposed at opposing ends of said central ridge; and
at least one corner edge, said at least one corner edge intersecting one of said proximal edges and one of said opposed edges.

2. The shield of claim 1, further comprising a first and a second plurality of vents disposed in said first and second sloped surfaces, respectively.

3. The shield of claim 2, wherein each of said vents is disposed along a bottom edge of a raised portion of said first and second sloped surfaces.

4. The shield of claim 1, further comprising a first flange portion and a second flange portion, said first and second flange portions being disposed at a different one of said opposed edges and being substantially perpendicular thereto.

5. The shield of claim 4, wherein said first and second flange portions are arranged and configured to contact the burner element, thereby supporting said vented burner shield above the burner element.

6. The shield of claim 5, wherein each of said first and second flange portions further comprises a first leg and a second leg configured to contact the barbecue grill, thereby supporting said shield above the burner element.

7. The shield of claim 1, further comprising four of said corner edges and said shield is substantially symmetrical about said central ridge.

8. The shield of claim 1, wherein said first and second sloped surfaces form an angle of approximately 120° therebetween.

9. The shield of claim 1, wherein said shield is supported at said opposing ends of said central ridge such that said shield is disposed above the burner element.

10. A burner element, for use in a grill, the burner element comprising:
a perforated body configured to distribute fuel within the grill;
a shield disposed above said burner element, said shield comprising:
a first and a second sloped surface each having a defined surface area; each of said first and second sloped surfaces having a proximal edge and a distal edge, said proximal edge being adjacent a central ridge and said first and second sloped surfaces sloping downwardly therefrom; and
a pair of opposed end portions, each of said opposed end portions being disposed at opposing ends of said central ridge and having a reduced surface area relative to said defined surface area.

11. The burner element of claim 10, wherein said shield further comprise a first and a second plurality of vents disposed in said first and second sloped surfaces, respectively.

12. The burner element of claim 10, wherein said shield further includes a first flange portion and a second flange portion, said first and second flange portions being disposed at a different one of said opposed edges and being substantially perpendicular thereto.

13. The burner element of claim 12, wherein said first and second flange portions are arranged and configured to contact the barbecue grill, thereby supporting said shield above the burner element.

14. The burner element of claim 13, wherein said shield further comprises four corner edges and said shield is substantially symmetrical about said central ridge.

15. The burner element of claim 10, wherein said first and second sloped surfaces form an angle of approximately 120° therebetween.

16. A barbecue grill including a burner element, the gas burner element comprising:
a perforated body configured to distribute heat within the grill;
a shield disposed above said burner element, said shield comprising:
a first and a second sloped surface; each of said first and second sloped surfaces having a proximal edge and a distal edge, said proximal edge being adjacent a central ridge and said first and second sloped surfaces sloping downwardly therefrom;
a pair of opposed edges, each of said opposed edges being disposed at opposing ends of said central ridge; and
at least one corner edge, said at least one corner edge intersecting one of said proximal edges and one of said opposed edges.

17. The barbecue grill of claim 16, further comprising a first and a second plurality of vents disposed in said first and second sloped surfaces, respectively.

18. The barbecue grill of claim 17, further comprising a first flange portion and a second flange portion, said first and second flange portions being disposed at a different one of said opposed edges and being substantially perpendicular thereto.

19. The barbecue grill of claim 18, wherein said first and second flange portions are arranged and configured to contact the barbecue grill, thereby supporting said shield above the burner element.
